(19) United States
(12) Patent Application Publication
(10) Pub. No.: US 2012/0070096 A1
(43) Pub. Date: Mar. 22, 2012

(54) IMAGING APPARATUS AND IMAGE RESTORATION METHOD

(76) Inventor: Ichiro Oyama, Osaka (JP)

(21) Appl. No.: 13/319,406

(22) PCT Filed: Apr. 20, 2011
(86) PCT No.: PCT/JP2011/002316

§ 371 Date: Nov. 8, 2011

(30) Foreign Application Priority Data
Apr. 23, 2010 (JP) 2010-100408

(51) Int. Cl. G06K 9/40

(52) U.S. Cl. 382/254

(57) ABSTRACT

Provided is an imaging apparatus capable of restoring a deteriorated image to a high-resolution image when the deteriorated image is restored based on a PSF image captured by an optical system. An imaging apparatus (10) includes: an optical system (1); a PSF capturing unit (2) acquiring point spread function (PSF) information captured by the optical system (1), correcting the PSF information, and outputting the corrected PSF information; a subject capturing unit (5) acquiring subject information captured by the optical system (1), and outputting the subject information; and an image restoration unit (6) performing a restore operation for restoring the subject information, based on the corrected PSF information and the subject information, wherein the PSF capturing unit (2) includes: a frequency-domain conversion unit (3) converting the PSF information into frequency-domain data, and outputting optical transfer function (OTF) information; and a low-frequency component gain smoothing unit (4) correcting the OTF information so as to decrease a ratio of a gain of a direct-current component to a gain of a low-frequency component that is not the direct-current component.

### TECHNICAL FIELD

The present invention relates to technology for restoring an image deteriorated when the image was captured to an image that is less deteriorated.

### BACKGROUND ART

Techniques for restoring an image deteriorated when the image was captured due to a factor such as defocus, blur, or aberration of an optical system to an image that is less deteriorated have been progressively developed. For example, with the technique disclosed is in Patent Literature 1, it is possible to obtain a restored image by correcting deterioration of a deteriorated image (captured image) that is deteriorated due to defocus, blur, aberration, or the like in accordance with a restore operation using a correction function having inverse characteristics of those of a point spread function (PSF) resulting from defocus, blur, aberration, or the like. In many cases, such correction functions are created using PSF data created by a computer based on design data or the like.

Further, with the technique disclosed in Patent Literature 2, when it is difficult to create PSF data, a restore operation for restoring a deteriorated image is performed using PSF data obtained by actual shooting.

### CITATION LIST

### Patent Literature

[PTL 1] Japanese Unexamined Patent Application Publication No. 62-127976
[PTL 2] Japanese Unexamined Patent Application Publication No. 2009-163642

### SUMMARY OF INVENTION

### Technical Problem

However, in the case where a restore operation for restoring a deteriorated image is performed using PSF data created by a computer based on design data or the like, a high-resolution restored image cannot be obtained when there is a big difference between a PSF indicated by the PSF data and the actual PSF due to, for instance, a large mounting error being generated when the camera is assembled. Thus, it may be necessary to perform image restoration using a PSF to image obtained by actual shooting, rather than using the PSF data created by the computer.

Also, in the case where a restore operation for restoring a deteriorated image is performed using a PSF image obtained by shooting a point light source, rather than using PSF data created by a computer as in Patent Literature 2, especially if unnecessary luminance (hereinafter, described as “noise” as appropriate) of an imaging device is high when the PSF image is captured, the PSF shown by the PSF image differs from the actual PSF. Consequently, this results in a problem that a high-resolution restored image cannot be obtained.

In view of this, the present invention has been conceived to solve the above problems, and an object thereof is to provide an imaging apparatus and an image restoration method that enable restoration of a deteriorated image to a high-resolution image when the deteriorated image is restored based on a PSF image captured by an optical system.

### Solution to Problem

In order to achieve the above object, an imaging apparatus according to an aspect of the present invention includes: an optical system; a PSF capturing unit configured to acquire point spread function (PSF) information captured by the optical system, correct the PSF information, and output the corrected PSF information; a subject capturing unit configured to acquire subject information captured by the optical system, and output the acquired subject information; and an image restoration unit configured to perform a restore operation for restoring the subject information, based on the corrected PSF information and the subject information, wherein the PSF capturing unit includes: a frequency-domain conversion unit configured to convert the PSF information into frequency-domain data, and output optical transfer function (OTF) information obtained as a result of the conversion; and a low-frequency component gain smoothing unit configured to correct the OTF information so as to decrease a ratio of a gain of a direct-current component to a gain of a low-frequency component that is not the direct-current component.

In this manner, the influence of random noise included in a PSF image can be reduced by correcting OTF information obtained as a result of converting PSF information captured by the optical system into the frequency domain so as to decrease the ratio of a direct-current component to a low-frequency component. Consequently, this enables restoration of a deteriorated image to a high-resolution image.

### Advantageous Effects of Invention

According to an imaging apparatus according to an aspect of the present invention, even when unnecessary luminance (especially, random noise that fluctuates with time) of a captured PSF image is high at the time of an image restore operation, OTF information is corrected so as to decrease a ratio of direct-current gain to low-frequency gain such that an average luminance value of the PSF image is appropriate, thereby obtaining more accurate restoration information. Consequently, high-resolution image restoration is possible.

### BRIEF DESCRIPTION OF DRAWINGS

FIG. 1 is a block diagram showing a configuration of an imaging apparatus according to an embodiment of the present invention.

FIG. 2 illustrates the relationship among an original image, a PSF, and a deteriorated image in the embodiment of the present invention.

FIG. 3 shows a PSF luminance distribution in the embodiment of the present invention.

FIG. 4 shows a simulator for verifying the influence exerted by noise on a restored image in the embodiment of the present invention.

FIG. 5 illustrates the relationship between noise included in a deteriorated image and a restored image in the embodiment of the present invention.

FIG. 6 illustrates the relationship between noise included in a PSF image and a restored image in the embodiment of the present invention.

FIG. 7 illustrates the relationship between a resolution of a restored image and noise included in a deteriorated image and a PSF image in the embodiment of the present invention.

FIG. 8 shows ideal PSF information in the embodiment of the present invention.

FIG. 9 shows PSF information including noise in the embodiment of the present invention.

FIG. 10 shows flowcharts showing the operation of the imaging apparatus according to the embodiment of the present invention.

FIG. 11 shows PSF information in the embodiment of the present invention.

FIG. 12 shows OTF information in the embodiment of the present invention.

FIG. 13 shows restored images in the embodiment of the present invention.

FIG. 14 shows the resolution of restored images in the embodiment of the present invention.

### DESCRIPTION OF EMBODIMENT

The following is a description of a factor that makes high-resolution image restoration difficult when unnecessary luminance (noise) of a captured PSF image is high, before giving a description of an embodiment of the present invention.

A factor that makes high-resolution image restoration difficult when noise of a captured PSF image is large will now be described with reference to FIGS. 2 to 9. (a) in FIG. 2 shows an original image (subject) having no deterioration. The image is a cuneal chart generally used when the resolution of a captured image is measured. (b) in FIG. 2 shows an example of a PSF image captured by an optical system.

Due to, for instance, defocus, blur, or aberration of the optical is system, a point image has finite spread as shown in (b) in FIG. 2. Accordingly, the original image in (a) in FIG. 2 will be formed on an imaging device via the optical system, as a deteriorated image having a lower resolution as shown in (c) in FIG. 2. It is known that a deteriorated image is expressed using convolution integral of an original image and a PSF image that has been normalized such that a luminance integral value of the entire image region is “1”.

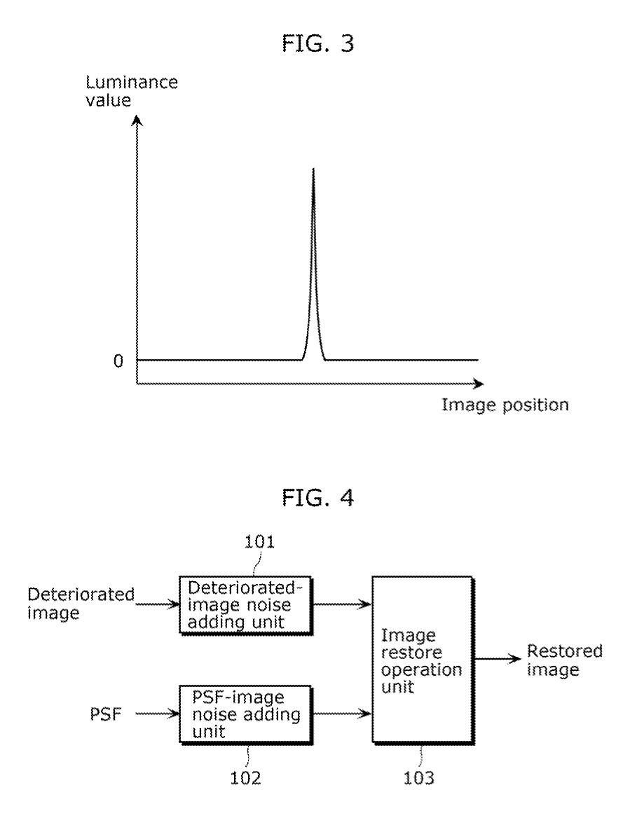

It should be noted that FIG. 3 shows a luminance distribution in an enlarged periphery of a region having the highest luminance on lines that include a portion having the highest luminance of the PSF image in (b) in FIG. 2. FIG. 3 shows a luminance distribution when the PSF image includes no noise. Although the expression of the luminance of an image differs depending on a system on which the present invention is mounted, “0” represents black, and “1.0” represents white, here.

FIG. 4 is a block diagram showing a simulator for examining the influence exerted by noise mixed in a deteriorated image and that in a PSF image when a subject image formed on the imaging device is captured. The simulator includes a deteriorated-image noise adding unit 101 that adds noise to a deteriorated image including no noise, a PSF-image noise adding unit 102 that adds noise to a PSF image including no noise, and an image restore operation unit 103. It is possible to examine the influence of noise exerted on each of the deteriorated image and the PSF image using this simulator.

Noise is assumed to be Gaussian noise. The influence of the noise can be examined by changing the standard deviation σ of the Gaussian noise. For example, if noise values at respective image positions are obtained in advance, this enables compensation, with ease, of fixed value noise that hardly changes with time depending on image positions (e.g., dark current noise, noise that occurs in predetermined lines or at predetermined pixel positions due to manufacturing defects of the imaging device, or the like), and thus such fixed value noise is not taken into consideration here. Specifically, the influence of noise is examined, taking into consideration only random noise (assumed to be Gaussian noise) that randomly changes with time and that is difficult to be compensated. It should be noted that an image position is a position on an image, and is typically a position of a pixel that constitutes the image. Further, Gaussian noise is noise in which the distribution of luminance values of noise components approximates a Gaussian distribution.

The image restore operation unit 103 may perform an image restore operation using an algorithm known as an image restore algorithm, such as the Wiener filter or the Richardson-Lucy algorithm. Here, the image restore operation unit 103 has a configuration of obtaining a restored image by performing an image restore operation using the Wiener filter.

For the configuration of the Wiener filter Hw(u, v), Expression 1 below, for example, may be used, which is described in Non Patent Literature (Digital Image Processing: CG-ARTS Society, Jul. 22, 2004, p. 146).

Hw(u,v)=1/H(u,v)·|H(u,v)̂2/(|H(u,v)|̂2+K) (Expression 1)

Here, H(u, v) represents an optical transfer function (OTF) that is the Fourier transform of a PSF image. Further, “u” represents the address of an array where frequency components in the vertical direction of the PSF image are stored. Also, “v” represents the address of an array where frequency components in the horizontal direction of the PSF image are stored. “K” is an appropriate constant.

The image restore operation unit 103 multiplies Fourier transform data of a deteriorated image by the Wiener filter Hw(u, v) for each frequency component, and generates a restored image by performing inverse Fourier transform on the multiplication results. The cuneal chart shown in (a) in FIG. 2 is used as a subject. The PSF-image noise adding unit 102 adds noise to the PSF image in (b) in FIG. 2 as necessary, and thereafter the obtained image is normalized such that the luminance integral value of the entire region is 1. The resultant image is used as a PSF image.

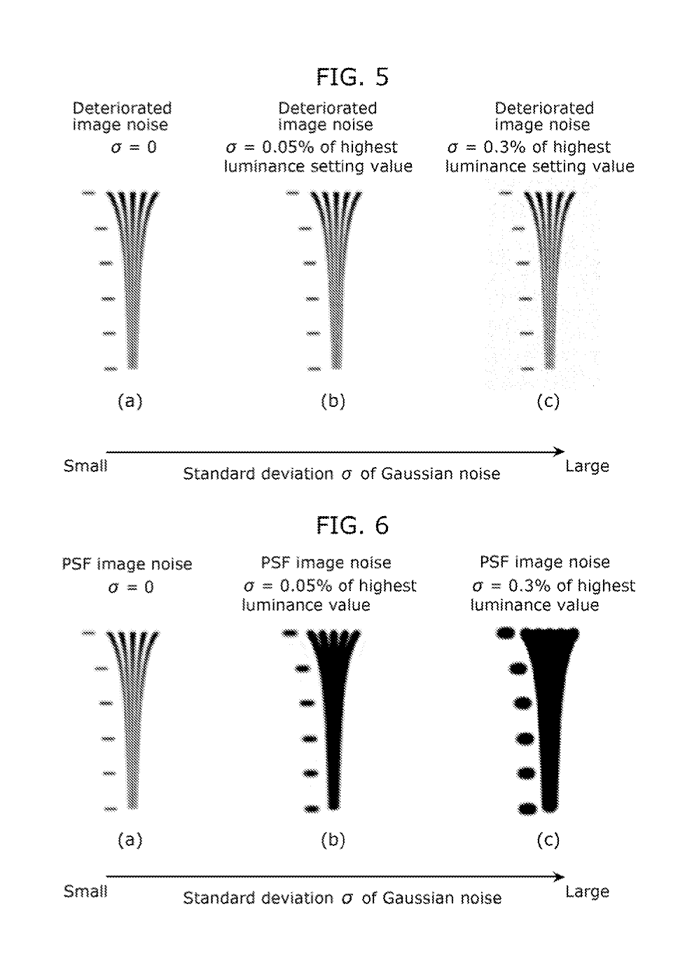

(a), (b), and (c) in FIG. 5 show restored images respectively corresponding to standard deviations σ in the case where the deteriorated-image noise adding unit 101 adds Gaussian noise whose standard deviation σ has been changed to the deteriorated image in (c) in FIG. 2. The PSF image and the deteriorated image are 512×512 pixel images, as examples.

Specifically, (a), (b), and (c) in FIG. 5 show restored images in the case where the standard deviation σ is set to 0%, 0.05%, and 0.3% of the highest luminance setting value (here, the highest luminance setting value is “1” since “0” indicates black, and “1.0” indicates white) of the deteriorated image. Noise is not added to the PSF image at this time. As is clear from (a), (b), and (c) in FIG. 5, the resolution of the restored images is slightly decreased as the standard deviation σ is increased. It should be noted that the highest luminance setting value is a value indicating the highest luminance among values that each indicate a luminance.

(a), (b), and (c) in FIG. 6 show restored images respectively corresponding to standard deviations a in the case where the PSF-image noise adding unit 102 adds Gaussian noise whose standard deviation σ has been changed to the PSF image in (b) in FIG. 2. Specifically, (a), (b), and (c) in FIG. 6 show restored images in the case where the standard deviation σ of Gaussian noise is set to 0%, 0.05%, and 0.3% of the highest luminance value of the PSF image. Noise is not added to the deteriorated image at this time. As is clear from (a), (b), and (c) in FIG. 6, the resolution of the restored images is significantly decreased as the standard deviation σ is increased.

It should be noted that the highest luminance value of the PSF image is a luminance value at an image position that shows the highest luminance in the PSF image. Specifically, the highest luminance value of the PSF image is a luminance value of a pixel that shows the highest luminance among pixels that constitute the PSF image, for example.

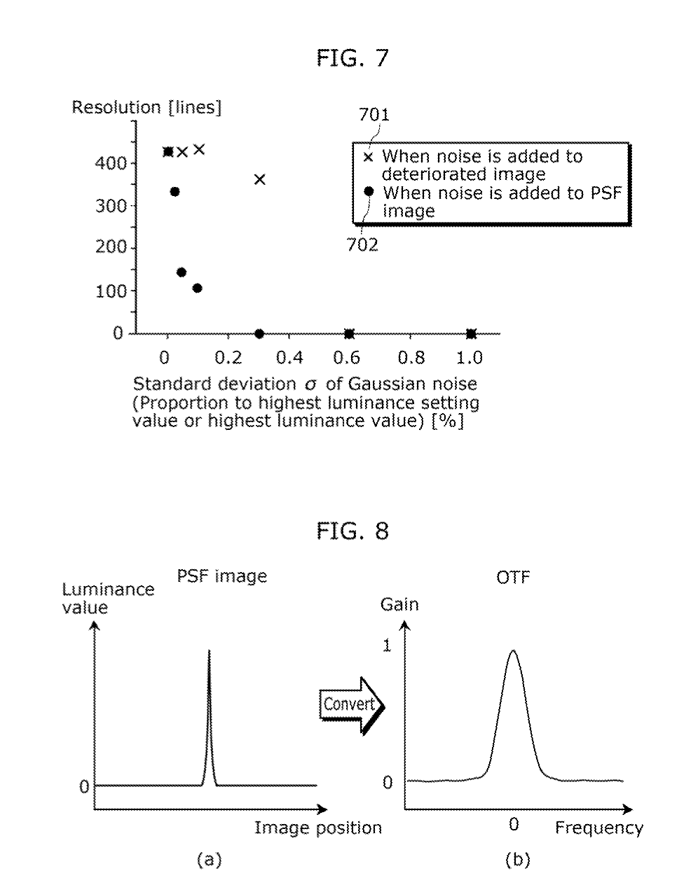

FIG. 7 shows the result of comparison of the change in the resolution of restored images in the case where the standard deviation a of Gaussian noise is changed. In FIG. 7, numeral 701 denotes the resolution of a restored image in the case where Gaussian noise is added only to a deteriorated image. Further, numeral 702 denotes the resolution of a restored image in the case where Gaussian noise is added only to a PSF image.

The standard deviation σ of Gaussian noise to be added to the deteriorated image is represented by the proportion to the highest luminance setting value. Further, the standard deviation σ of Gaussian noise to be added to the PSF image is represented by the proportion to the highest luminance value. Here, when Gaussian noise is added to the PSF image, the PSF image has been normalized such that the highest luminance value is the highest luminance setting value “1.0”, and comparison is performed on the condition that the same noise is added to the deteriorated image and the PSF image.

The resolution is measured using the resolution measurement tool HYRes3.1 distributed by CIPA, with reference to CIPA DC-003 “Resolution Measurement Methods for Digital Cameras”. The resolution measured in this manner indicates that the more lines are measured, the higher the resolution is. It should be noted that in the embodiment of the present invention, the number of lines of resolution of a restored image that is restored in the case where Gaussian noise is not added to either the deteriorated image or the PSF image is 428.

As is clear from FIG. 7, the resolution of a restored image changes depending on the ratio between an image signal and the standard deviation σ of Gaussian noise. Further, it can be seen that when the standard deviation σ of Gaussian noise is increased, the resolution of the PSF image more significantly decreases compared with that of the deteriorated image.

In the case where Gaussian noise is added only to the deteriorated image, when the standard deviation σ of Gaussian noise is equal to or greater than 0.6% of the highest luminance setting value, the resolution significantly decreases, and the number of lines of resolution becomes 0 (which cannot be measured). On the other hand, in the case where Gaussian noise is added only to the PSF image, when the standard deviation σ of Gaussian noise is equal to or greater than 0.3% of the highest luminance value, the resolution significantly decreases, and the number of lines of resolution becomes 0.

Consequently, it has been found that noise included in the PSF image has greater negative influence on a restored image than the noise included in the deteriorated image. Note that when the resolution of the deteriorated image in (c) in FIG. 2, which has not been restored, is measured, the result will indicate that measurement cannot be performed because of the influence of blur due to aberration, regardless of whether noise is included, and the number of lines of the resolution is 0.

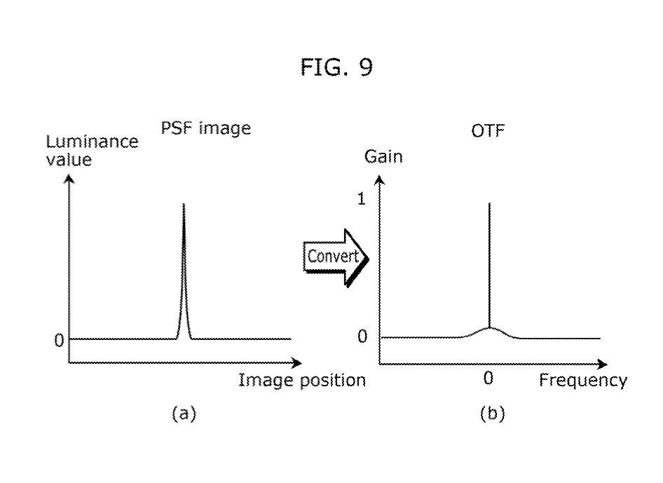

The result obtained by verifying the factor of a great decrease in the resolution of a restored image due to noise included in the PSF image will be described with reference to FIGS. 8 and 9.

(a) in FIG. 8 shows a luminance distribution of enlarged lines in the periphery of a portion having the highest luminance of the PSF image in (b) in FIG. 2. Here, the PSF image does not include noise.

(b) in FIG. 8 shows the gain of an OTF that is the Fourier transform of the PSF image that does not include noise. The OTF in (b) in FIG. 8 has been normalized such that the gain of the direct-current component (at a frequency of 0) is 1. The horizontal axis in (b) in FIG. 8 represents frequency, and the right side thereof relative to the direct-current component (at a frequency of 0) represents positive frequency, whereas the left side thereof represents negative frequency. For the PSF image in (b) in FIG. 2, an example is used in which a luminance distribution is symmetrical with the image position having the highest luminance being the center. In view this, to simplify the gain distribution, in (b) in FIG. 8 and the following drawings that show an OTF, one line's worth data including direct-current component data in the vertical and horizontal directions in the two-dimensionally arrayed OTF is extracted and displayed.

(a) in FIG. 9 shows a luminance distribution of enlarged lines in the periphery of a portion having the highest luminance of an image obtained by adding Gaussian noise whose standard deviation σ is 0.3% of the highest luminance value to the PSF image in (b) in FIG. 2. (b) in FIG. 9 shows the gain of an OTF that is the Fourier transform of the PSF image that includes this noise. The OTF in (b) in FIG. 9 has also been normalized such that the gain of the direct-current component (at a frequency of 0) is 1.

Compared with (b) in FIG. 8, it can be seen from (b) in FIG. 9 that the gain of a component at a frequency of 0 (direct-current component) is much greater compared with the gain of other frequency components. A conceivable reason for this is that most of the entire PSF image in (b) in FIG. 2 is a region having a low luminance, and the addition of noise to that low-luminance region greatly changes the average luminance value (=direct-current component) of the entire PSF image.

Therefore, the resolution of a restored image is greatly decreased due to an increase in the difference between the OTF of the captured PSF image and the actual OTF. It should be noted that even if a general filter that reduces random noise such as a median filter is caused to operate on the PSF image, it is difficult to completely eliminate random noise from a region of the PSF image where the luminance is low. Thus, it is difficult to eliminate a change in the average luminance value of the entire PSF image.

As described above, in the case where a deteriorated image is restored using a captured PSF image, the average luminance value of the PSF image changes due to the influence of random noise (Gaussian noise), which is difficult to be corrected, thereby causing a great change in the direct-current component of the frequency components of the PSF. Consequently, a high-resolution restored image cannot be obtained. Such a problem is revealed by the examination using the simulator in FIG. 4.

In view of the above, the following is a description of an imaging apparatus according to one aspect of the present invention, the apparatus being capable of solving the above problems.

### Embodiment

The following is a description of an embodiment of the present invention with reference to the drawings.

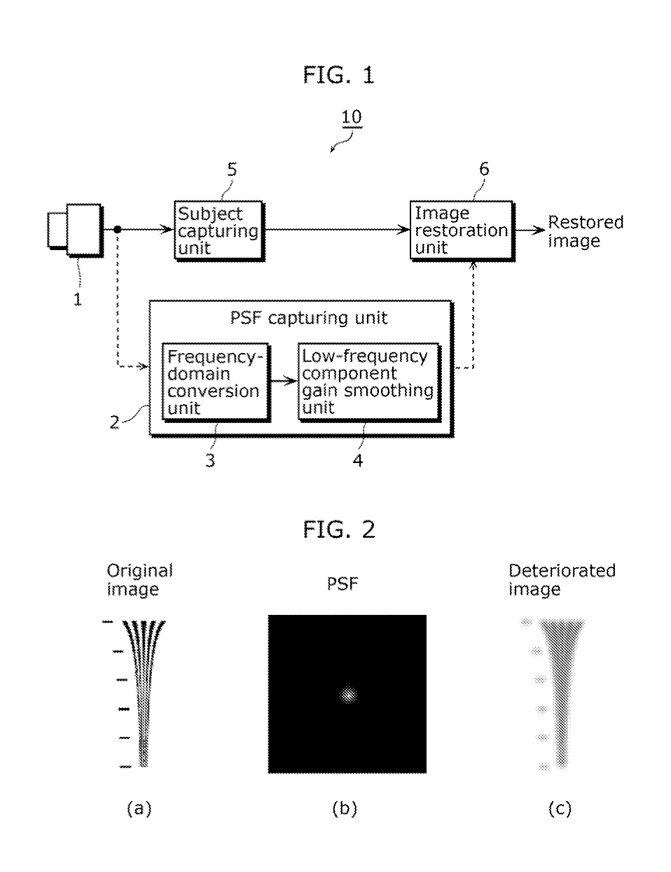

FIG. 1 is a block diagram showing an example of a configuration of an imaging apparatus according to the embodiment of the present invention. An imaging apparatus 10 includes an optical system 1, a PSF capturing unit 2 including a frequency-domain conversion unit 3 and a low-frequency component gain smoothing unit 4, a subject capturing unit 5, and an image restoration unit 6.

The optical system 1 captures a subject image. Specifically, the optical system 1 includes a lens and an imaging device, for example. The optical system 1 generates a PSF image I_psf(x, y) by capturing a point image or a subject image corresponding to a point image. Further, the optical system 1 generates a subject image I_img(x, y) by capturing an arbitrary subject image.

The PSF capturing unit 2 causes the optical system 1 to capture a point image or a subject image corresponding thereto in order to acquire a PSF corresponding to the optical system 1, obtains the PSF image I_psf(x, y) from the optical system 1, and stores the image. Here, x represents an image position in the vertical direction in the image, whereas y represents an image position in the horizontal direction.

In other words, the PSF capturing unit 2 acquires PSF information. Here, PSF information is based on the PSF image I_psf(x, y) captured by the optical system 1. Specifically, PSF information indicates the PSF image I_psf(x, y) itself, for example. Alternatively, PSF information may be information obtained by converting the PSF image I_psf(x, y) from the spatial domain into the frequency domain, for example.

It should be noted that the PSF image I_psf(x, y) is preferably an image captured such that the highest luminance value is close to a highest luminance setting value “1.0” to minimize the influence of noise. Further, when there is known fixed value noise that does not change with time depending on image positions (e.g., dark current noise, noise that occurs in predetermined lines or at predetermined image positions due to manufacturing defects of the imaging device, or the like), the PSF capturing unit 2 subtracts a luminance value Nf(x, y) of the fixed value noise obtained in advance at each image position of the PSF image I_psf(x, y) from the PSF image I_psf(x, y) as shown by Expression 2.

Ir1_psf(x,y)=I_psf(x,y)−Nf(x,y) (Expression 2)

Here, the PSF capturing unit 2 corrects the luminance value at an image position having a negative luminance value in the PSF image Ir1_psf(x, y) obtained as a result of subtracting the luminance value of the fixed value noise to “0”.

It should be noted that the PSF capturing unit 2 need not necessarily subtract the luminance value Nf(x, y) of the fixed value noise from the PSF image I_psf(x, y). For example, when, for instance, it is known in advance that the fixed value noise has a substantially constant value in the entire image region, the PSF capturing unit 2 does not need to subtract the luminance value Nf(x, y) of the fixed value noise from the PSF image I_psf(x, y).

In the above manner, the PSF capturing unit 2 acquires PSF information. Here, PSF information is based on the PSF image I_psf(x, y) captured by the optical system 1. Specifically, PSF information indicates the PSF image I_psf(x, y), for example. Further, for example, PSF information may indicate a PSF image Ir1_psf(x, y) obtained by subtracting the luminance value Nf(x, y) of the fixed value noise from the PSF image I_psf(x, y).

It should be noted that the PSF image Ir1_psf (x, y) obtained by subtracting the luminance value Nf(x, y) of the fixed value noise from the PSF image I_psf(x, y) may be simply referred to as a PSF image Ir1_psf(x, y).

The frequency-domain conversion unit 3 converts the PSF image Ir1_psf(x, y) from the spatial domain into frequency-domain data using a Fourier transform technique such as a fast Fourier transform (FFT), thereby generating OTF information H_psf(u, v). In other words, the frequency-domain conversion unit 3 converts PSF information into frequency-domain data, and outputs OTF information obtained as a result of the conversion. Specifically, the frequency-domain conversion unit 3 converts the PSF image Ir1_psf(x, y) indicated by the PSF information from the spatial domain into the frequency domain, and outputs OTF information H_psf(u, v) obtained as a result of the conversion.

The low-frequency component gain smoothing unit 4 corrects the OTF information H_psf(u, v) so as to decrease a ratio Gain_H_psf(u0, v0)/Gain_low_freq of a direct-current component gain Gain_H_psf(u0, v0) to a low-frequency component gain Gain_low_freq in the OTF information H_psf(u, v).

The gain of a low frequency component is a gain obtained from frequency components at frequencies lower than a predetermined frequency except the frequency of the direct-current component. Specifically, the gain of a low frequency component is a gain obtained from frequency components at frequencies near the frequency of the direct-current component. For example, the gain of a low frequency component is an average value of frequency components at frequencies adjacent to the frequency of the direct-current component. Here, the low-frequency component gain Gain_low_freq is an average value of Gain_H_psf(u0, v0+1) and Gain_H_psf(u0+1, v0) in each of which a value of a gain of a frequency component at the lowest frequency except the frequency of the direct-current component in the OTF information H_psf (u, v) is stored.

“u0” represents the address at which the value of the direct-current component is stored, the address being of an array where frequency components in the vertical direction of the PSF image are stored. Further, “v0” represents the address at which the value of the direct-current component is stored, the address being of an array where frequency components in the horizontal direction of the PSF image are stored.

In this manner, the PSF capturing unit 2 corrects the OTF information H_psf(u, v), and outputs corrected PSF information Hr_psf(u, v) obtained as a result of the correction.

It should be noted that the corrected PSF information Hr_psf(u, v) is normalized as necessary, and the result is output. The reason for correcting the OTF information H_psf(u, v) and the setting range of Gain_H_psf(u0, v0)/Gain_low_freq will be described below.

The subject capturing unit 5 stores subject images I_img(x, y) of various subjects acquired by the optical system 1. The subject capturing unit 5 may perform compensation of the fixed value noise or noise compensation processing such as median filtering on the subject images I_img(x, y), as necessary.

Specifically, the subject capturing unit 5 acquires a subject image I_img(x, y) captured by the optical system 1, and outputs subject information. Here, subject information is information based on the acquired subject image I_img(x, y). For example, subject information is information that indicates the subject image I_img(x, y) itself. Further, subject information may be information that indicates an image obtained by performing various types of noise compensation processing on the subject image I_img(x, y), for example. Also, subject information may be information obtained by converting the subject image I_img(x, y) or an image obtained as a result of performing various types of noise compensation processing on the subject image I_img(x, y) from the spatial domain into the frequency domain, for example.

The image restoration unit 6 performs an image restore operation using a Wiener filter or the like based on the corrected PSF information and the subject information, and generates a restored image. Specifically, the image restoration unit 6 performs a restore operation for restoring subject information based on the corrected PSF information and the subject information. In other words, the image restoration unit 6 generates a restored image having a higher resolution than that of the image indicated by the subject information by performing an image restore operation for causing the corrected PSF information to affect the subject information.

Specifically, for example, the image restoration unit 6 converts the subject image I_img(x, y) indicated by the subject information from the spatial domain into the frequency domain, and causes the corrected PSF information Hr_psf(u, v) to affect the result of the conversion, thereby performing a restore operation.

It should be noted that the corrected PSF information Hr_psf(u, v) may be data once captured and computed at the time of factory shipment, maintenance, or the like. Specifically, it is sufficient for the image restoration unit 6 to have a storage means such as a memory, store in advance the corrected PSF information Hr_psf(u, v) generated by the PSF capturing unit 2, and generate a restored image using the stored corrected PSF information Hr_psf(u, v). In other words, the PSF capturing unit 2 need not necessarily generate corrected PSF information Hr_psf(u, v) each time a subject image I_img(x, y) is changed.

Next is a description of various operations of the imaging apparatus having the above configuration according to the present embodiment.

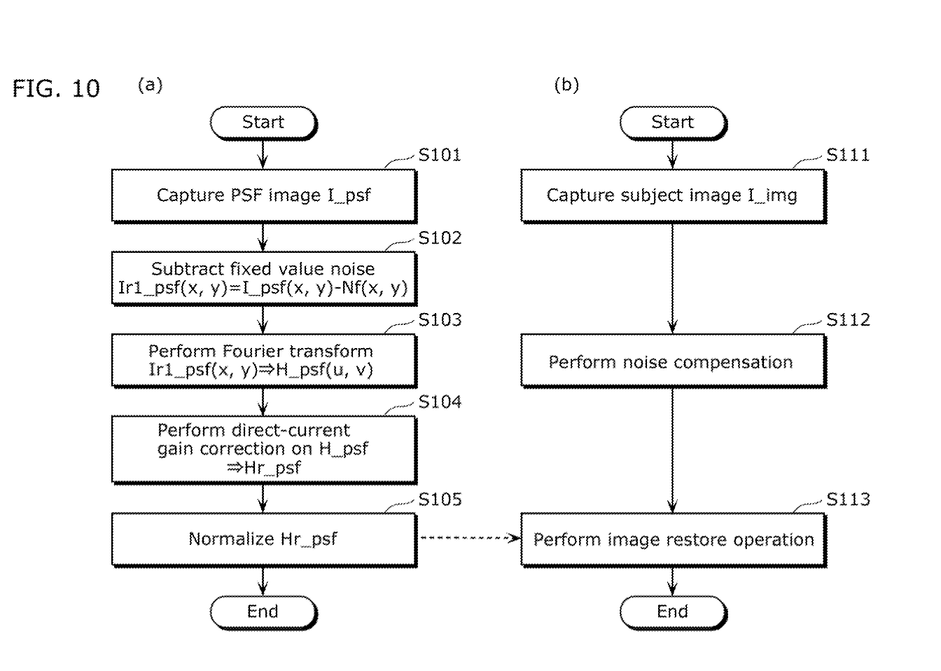

FIG. 10 shows flowcharts showing the operation of the above-described imaging apparatus according to Embodiment 1 of the present invention. Specifically, (a) in FIG. 10 is a flowchart showing the flow of corrected PSF information generation processing. Further, (b) in FIG. 10 is a flowchart showing the flow of image restore processing. As described above, it is sufficient to perform the processing shown in (a) in FIG. 10 at least once prior to the processing shown in (b) in FIG. 10, and the processing shown in the drawings need not necessarily be performed in synchronization.

First is a description of the flowchart shown in (a) in FIG. 10.

The optical system 1 captures a PSF image I_psf(x, y) (S101). Next, the PSF capturing unit 2 subtracts the luminance value Nf(x, y) of the fixed value noise from the PSF image I_psf(x, y) in accordance with Expression 2, and thereby obtains a PSF image Ir1_psf(x, y) as a result of subtracting the luminance value of the fixed value noise (S102).

Then, the frequency-domain conversion unit 3 converts the PSF image Ir1_psf(x, y) obtained by subtracting the luminance value of the fixed value noise from the spatial domain into the frequency domain, and thereby obtains OTF information H_psf(u, v) (S103). Next, the low-frequency component gain smoothing unit 4 corrects the OTF information H_psf(u, v) so as to decrease the ratio of the gain of the direct-current component to the gain of a low frequency component, thereby generating corrected PSF information Hr_psf(u, v) (S104). At last, the PSF capturing unit 2 normalizes the generated corrected PSF information Hr_psf(u, v), and outputs the result to the image restoration unit 6 (S105).

It should be noted that fixed value noise subtraction processing in step S102 need not necessarily be executed. For example, the PSF capturing unit 2 may not execute fixed value noise subtraction processing when the fixed value noise is very small, when it is known that the fixed value noise is a substantially constant value in the entire image region, or the like.

Next is a description of the flowchart shown in (b) in FIG. 10.

The optical system 1 captures a subject image I_img(x, y) (S111). Next, the subject capturing unit 5 performs noise compensation processing on the subject image I_img(x, y) on which noise compensation processing has been performed (S112). At last, the image restoration unit 6 performs a restore operation based on the subject image I_img(x, y) on which noise compensation processing has been performed and the corrected PSF information Hr_psf(u, v), thereby generating a restored image (S113).

It should be noted that noise compensation processing in step S112 need not necessarily be executed.

The following is a description of the reason for correcting OTF information H_psf and the setting range of Gain_H_psf(u0, v0)/Gain_low_freq. In the following description, a deteriorated image of the cuneal chart shown in (c) in FIG. 2 is used as a subject image I_img(x, y). An image obtained by adding Gaussian noise whose standard deviation σ is 0.3% of the highest luminance value to the PSF image in (b) in FIG. 2 is used as a PSF image Ir1_psf(x, y) (a luminance value at an image position having a negative luminance value is corrected to 0).

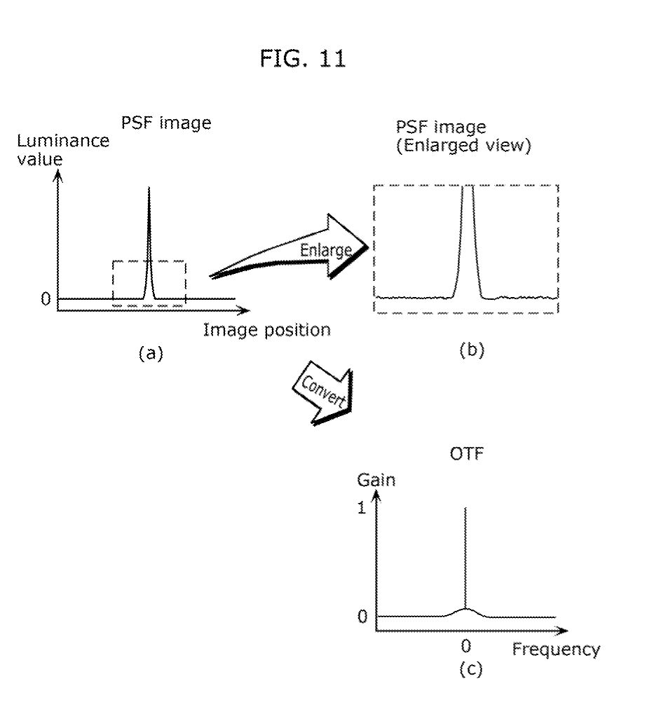

(a) in FIG. 11 shows a luminance distribution on lines that include the position of the highest luminance value of the PSF image Ir1_psf(x, y). Since fixed value noise has been eliminated, a portion around the position of the highest luminance value has a luminance distribution based on the PSF of the optical system 1 in FIG. 1, and the luminance value is substantially 0 at positions distant from the position of the highest luminance.

(b) in FIG. 11 shows a luminance distribution of an enlarged portion in the vicinity of the dashed line in (a) in FIG. 11. It can be seen that there is a slight luminance distribution (slight fluctuation in the luminance value) even at positions distant from the position of the highest luminance value, due to the influence of Gaussian noise that is randomly distributed.

(c) in FIG. 11 shows OTF information H_psf(u, v) obtained by performing Fourier transform on the PSF image Ir1_psf(x, y). The OTF information H_psf(u, v) in (c) in FIG. 11 has been normalized such that the gain of the direct-current component (at a frequency of 0) is “1”. As is clear from (c) in FIG. 11, the direct-current component has to significantly higher gain than that of other frequency components. A conceivable reason for this is a great increase in the average luminance value of the entire PSF image Ir1_psf(x, y) due to Gaussian noise as described above.

Therefore, when an image restore operation is performed using the PSF image Ir1_psf(x, y), the resolution of the restored image greatly decreases due to an increase in the difference between the OTF indicated by the OTF information H_psf(u, v) in (c) in FIG. 11 and the actual OTF. In view of this, in the present embodiment, the difference between the gain of the direct-current component and the gain at other frequencies in the OTF information H_psf(u, v) is corrected so as to obtain an OTF close to the actual OTF, thereby enabling high-resolution image restoration.

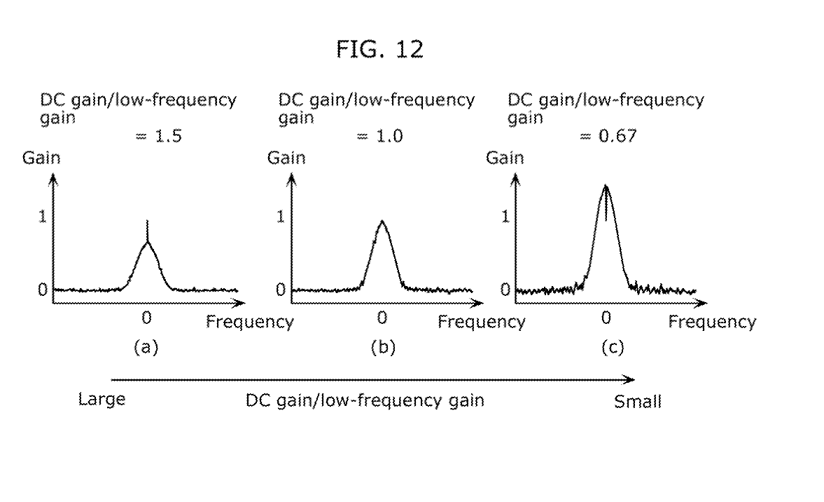

FIG. 12 shows corrected PSF information Hr_psf(u, v) obtained when OTF information H_psf(u, v) is corrected so as to decrease Gain_H_psf(u0, v0)/Gain_low_freq. The corrected PSF information Hr_psf(u, v) in FIG. 12 has been normalized such that the gain of the direct-current component (at a frequency of 0) is “1”. (a) in FIG. 12 to shows corrected PSF information Hr_psf(u, v) obtained when the OTF information H_psf(u, v) is corrected such that Gain_H_psf(u0, v0)/Gain_low_freq is 1.5. Further, (b) in FIG. 12 shows corrected PSF information Hr_psf(u, v) obtained when the OTF information H_psf(u, v) is corrected such that Gain_H_psf(u0, v0)/Gain_low_freq is 1.0. Further, (c) in FIG. 12 shows corrected PSF information Hr_psf(u, v) obtained when the OTF information H_psf(u, v) is corrected such that Gain_H_psf(u0, v0)/Gain_low_freq is 0.67.

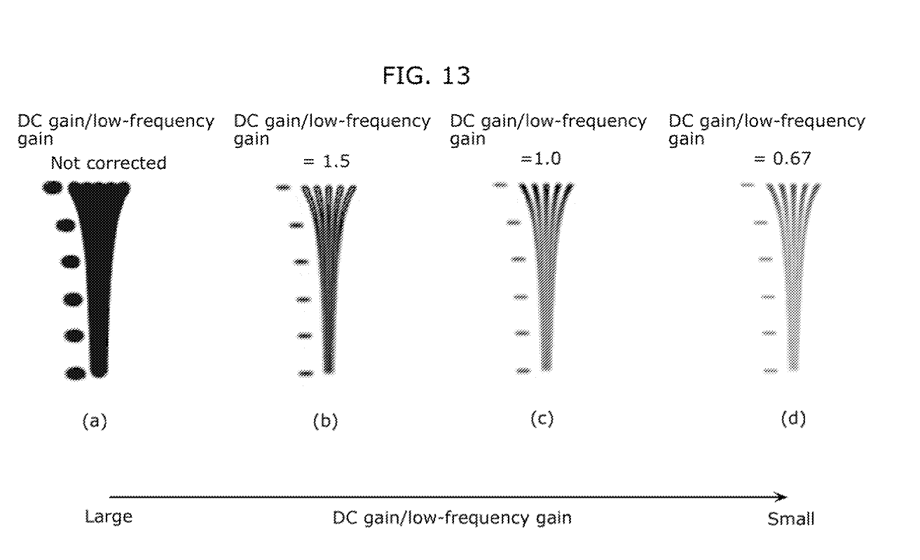

FIG. 13 shows restored images obtained when an image restore operation is performed using the corrected PSF information shown in FIG. 12. (a) in FIG. 13 shows a restored image obtained when the OTF information H_psf(u, v) is not corrected. (b) in FIG. 13 shows a restored image obtained when the OTF information H_psf(u, v) is corrected such that Gain_H_psf(u0, v0)/Gain_low_freq is 1.5. (c) in FIG. 13 shows a restored image obtained when the OTF information H_psf(u, v) is corrected such that Gain_H_psf(u0, v0)/Gain_low_freq is 1.0. (d) in FIG. 13 shows a restored image obtained when the OTF information H_psf(u, v) is corrected such that Gain_H_psf(u0, v0)/Gain_low_freq is 0.67.

As is clear from FIG. 13, the resolution of the restored images is improved by correcting the OTF information H_psf(u, v) so as to decrease Gain_H_psf(u0, v0)/Gain_low_freq.

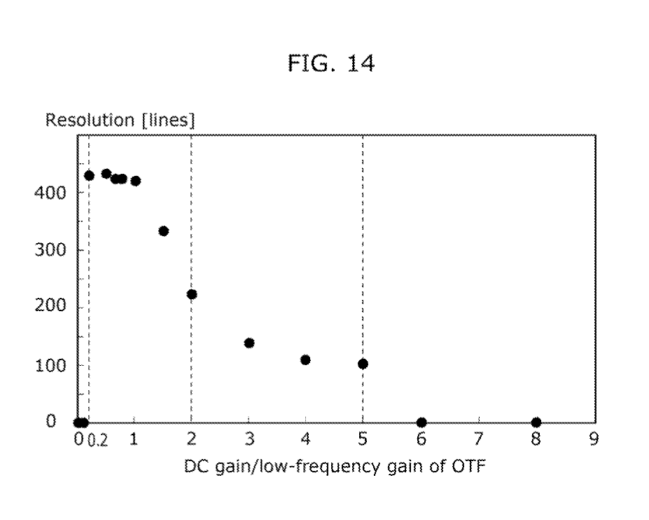

FIG. 14 shows a change in the resolution when Gain_H_psf(u0, v0)/Gain_low_freq is changed. In the graph shown in FIG. 14, the vertical axis represents the resolution of restored images measured using the resolution measurement tool HYRes3.1 distributed from CIPA, whereas the horizontal axis represents DC gain/low-frequency gain (=Gain_H_psf(u0, v0)/Gain_low_freq) of the corrected PSF information.

As is clear from FIG. 14, the resolution is improved when OTF information H_psf(u, v) is corrected such that DC gain/low-frequency gain is from 0.2 to 5. In other words, it is preferable that the low-frequency component gain smoothing unit 4 correct the OTF information H_psf(u, v) such that the ratio of the gain of the direct-current component to the gain of a low-frequency component that is not the direct-current component is from 0.2 to 5.

Furthermore, when the OTF information H_psf(u, v) is corrected such that DC gain/low-frequency gain is from “0.2” to “2.0”, half the resolution or higher of that of an image having no Gaussian noise can be obtained. In other words, it is preferable that the low-frequency component gain smoothing unit 4 correct the OTF information H_psf(u, v) such that the ratio of the gain of the direct-current component to the gain of a low-frequency component that is not the direct-current component is from 0.2 to 2.

Furthermore, when the OTF information H_psf(u, v) is corrected such that DC gain/low-frequency gain is “0.2” to “1.0”, the same resolution as that of an image having no Gaussian noise can be obtained. In other words, it is preferable that the low-frequency component gain smoothing unit 4 correct the OTF information H_psf(u, v) such that the ratio of the gain of the direct-current component to the gain of a low-frequency component that is not the direct-current component is from 0.2 to 1.

When DC gain/low-frequency gain is smaller than “0.2”, the DC gain is excessively decreased compared with the gain of other frequency components, and the difference between the OTF indicated by the corrected PSF information Hr_psf(u, v) obtained as a result of the correction and the actual OTF will be excessively increased. Consequently, the resolution of a restored image is greatly decreased.

The above result shows that when the OTF information H_psf(u, v) is corrected such that DC gain/low-frequency gain is “1” as shown in (b) in FIG. 12, the OTF indicated by the corrected PSF information Hr_psf(u, v) is close to the actual OTF, and thus the resolution of a restored image is improved. Furthermore, it has been found that the resolution of a restored image is improved when OTF information H_psf(u, v) is corrected such that DC gain/low-frequency gain is in the predetermined range described above, not “1”.

As described above, according to the imaging apparatus 10 according to the embodiment of the present invention, even when unnecessary luminance (especially, random noise that fluctuates with time) of a captured PSF image is high at the time of an image restore operation, OTF information H_psf(u, v) is corrected such that DC gain/low-frequency gain will be an appropriate value, thereby obtaining more accurate PSF information for restoring the image. Consequently, high-resolution image restoration is possible.

It should be noted that although the corrected PSF information Hr_psf(u, v) output from the PSF capturing unit 2 is described as frequency-domain data, the corrected PSF information may be spatial-domain data. For example, when the Richardson-Lucy algorithm for an operation using the spatial domain is used as an operation algorithm used by the image restoration unit 6, the PSF capturing unit 2 may perform inverse Fourier transform on the corrected PSF information Hr_psf(u, v) as necessary, and output image-domain data. In other words, the PSF capturing unit 2 may convert data into an appropriate data format according to latter processing performed by the PSF capturing unit 2, and output corrected PSF information obtained as a result of the conversion.

It should be noted that although the low-frequency component gain smoothing unit 4 uses an average value of gains of lowest-frequency components except the direct-current component as the low-frequency component gain Gain_low_freq, the present invention is not limited to this. For example, the low-frequency component gain Gain_low_freq may be determined based on the gain of a low-frequency component except the direct-current component, such as the largest or smallest value of the gain at the lowest frequency except the direct-current component, or an average value of gains of components including other low-frequency components.

It should be noted that the PSF capturing unit 2 need not necessarily subtract the luminance value of the fixed value noise in accordance with Expression 2. The PSF capturing unit 2 need not necessarily subtract the luminance value of the fixed value noise when the fixed value noise is a substantially constant value in the entire image region, for example. In other words, it is sufficient for the PSF capturing unit 2 to subtract the luminance value of the fixed value noise from the luminance value of the PSF image as necessary, and thus it goes without saying that subtraction of the luminance value of the fixed value noise is not required.

It should be noted that although the present embodiment has to been described using an example in which the PSF has a symmetrical luminance distribution with the image position having the highest luminance being the center as shown in (b) in FIG. 2, it goes without saying that the present invention is applicable to an optical system having an asymmetrical PSF luminance distribution.

Although the above is a description of the imaging apparatus 10 according to an aspect of the present invention based on the embodiment, the present invention is not limited to the embodiment. The scope of the present invention includes various modifications to the embodiment that may be conceived by those skilled in the art, which do not depart from the essence of the present invention.

For example, although the imaging apparatus 10 includes the PSF capturing unit 2 in the above embodiment, the imaging apparatus 10 need not necessarily include the PSF capturing unit 2. Specifically, it is sufficient for the imaging apparatus 10 to store corrected PSF information generated in advance. Even in this case, the imaging apparatus 10 can restore a high-resolution subject image since the imaging apparatus 10 can perform a restore operation for restoring subject information based on the corrected PSF information stored in advance and the subject information.

Further, a part or all of the constituent elements included in the imaging apparatus 10 in the above embodiment may be constituted by a single system large scale integration (LSI). For example, the imaging apparatus 10 may be constituted by a system LST having the PSF capturing unit 2, the subject capturing unit 5, and the image restoration unit 6.

The system LSI is a super multi-function LSI that is manufactured by integrating multiple components in one chip, and is specifically a computer system configured so as to include a microprocessor, a read only memory (ROM), a random access memory (RAM), and so on. A computer program is stored in the RAM. The system LSI accomplishes its functions through the operation of the microprocessor in accordance with the computer program.

It should be noted that although a system LSI is mentioned here, the integrated circuit can also be called an IC, an LSI, a super LSI, and an ultra LSI, depending on the difference in the degree of integration. Furthermore, the method of circuit integration is not limited to LSIs, and implementation through a dedicated circuit or a general-purpose processor is also possible. A field programmable gate array (FPGA) that allows programming after LSI manufacturing or a reconfigurable processor that allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

Further, the present invention can be implemented, not only as an imaging apparatus that includes such characteristic processing units as those described above, but also as an image restoration method having, as steps, the characteristic processing units included in such an imaging apparatus. Furthermore, the present invention can also be realized as a computer program that causes a computer to execute the characteristic steps included in the image restoration method. In addition, it goes without saying that such a computer program can be distributed via a computer-readable recording medium such as a compact disk read-only memory (CD-ROM) or via a communication network such as the Internet.

### INDUSTRIAL APPLICABILITY

The present invention is useful in imaging apparatuses in general that capture a subject image using an optical system, such as a digital still camera, a digital video camera, a mobile telephone camera, a monitoring camera, a medical camera, a telescope, a microscope, a vehicle-installed camera, a stereo ranging camera, a stereoscopic video shooting multi-lens camera, a light beam space capture camera for free-viewpoint video creation, an extended depth of field camera (EDOF), and a camera using flexible depth of field (FDOF) photography.

### REFERENCE SIGNS LIST

1 Optical system
2 PSF capturing unit
3 Frequency-domain conversion unit
4 Low-frequency component gain smoothing unit
5 Subject capturing unit
6 Image restoration unit
10 Imaging apparatus
101 Deteriorated-image noise adding unit
102 PSF-image noise adding unit
103 Image restore operation unit

1. An imaging apparatus comprising:
an optical system;
a PSF capturing unit configured to acquire point spread function (PSF) information captured by said optical system, correct the PSF information, and output the corrected PSF information;
a subject capturing unit configured to acquire subject information captured by said optical system, and output the acquired subject information; and
an image restoration unit configured to perform a restore operation for restoring the subject information, based on the corrected PSF information and the subject information,
wherein said PSF capturing unit includes:
a frequency-domain conversion unit configured to convert the PSF information into frequency-domain data, and output optical transfer function (OTF) information obtained as a result of the conversion; and
a low-frequency component gain smoothing unit configured to correct the OTF information so as to decrease a ratio of a gain of a direct-current component to a gain of a low-frequency component that is not the direct-current component.

2. The imaging apparatus according to claim 1,
wherein said low-frequency component gain smoothing unit is configured to correct the OTF information such that the ratio of the gain of the direct-current component to the gain of the low-frequency component that is not the direct-current component is from 0.2 to 5.

3. The imaging apparatus according to claim 1,
wherein said low-frequency component gain smoothing unit is configured to correct the OTF information such that the ratio of the gain of the direct-current component to the gain of the low-frequency component that is not the direct-current component is from 0.2 to 1.

4. An imaging apparatus comprising:
an optical system;
a subject capturing unit configured to acquire subject information captured by said optical system, and output the acquired subject information; and
an image restoration unit configured to perform a restore operation for restoring the subject information, based on corrected point spread function (PSF) information stored in advance and the subject information,
wherein the corrected PSF information is information generated by correcting optical transfer function (OTF) information so as to decrease a ratio of a gain of a direct-current component to a gain of a low-frequency component that is not the direct-current component, the OTF information being obtained by converting PSF information captured by said optical system into frequency-domain data.

5. An image restoration method comprising:
acquiring point spread function (PSF) information captured by an optical system, correcting the PSF information, and outputting the corrected PSF information;
acquiring subject information captured by the optical system, and outputting the acquired subject information; and
performing a restore operation for restoring the subject information, based on the corrected PSF information and the subject information,
wherein said acquiring of PSF information includes:
converting the PSF information into frequency-domain data, and outputting optical transfer function (OTF) information obtained as a result of the conversion; and
correcting the OTF information so as to decrease a ratio of a gain of a direct-current component to a gain of a low-frequency component that is not the direct-current component.

6. A program for causing a computer to execute the image restoration method according to claim 5.
